(19) United States
(12) Patent Application Publication
(10) Pub. No.: US 2007/0064538 A1
(43) Pub. Date: Mar. 22, 2007

(54) Sonar antenna

(76) Inventors: Mark Ian Jefree, New South Wales (AU); Rory Niland, New South Wales (AU)

Correspondence Address: FISH & RICHARDSON, PC, P.O. BOX 1022, MINNEAPOLIS, MN, 55440-1022, US

(21) Appl. No.: 10/567,060

(22) PCT Filed: Jul. 30, 2004
(86) PCT No.: PCT/AU04/01020

§ 371 Date: May 22, 2006

(30) Foreign Application Priority Data
Aug. 1, 2003 (AU) 2003904061

(51) Int. Cl. G01S 15/00

(52) U.S. Cl. 367/103

(57) ABSTRACT

This invention concerns a sonar antenna. The sonar antenna comprises an axially symmetric acoustic surface having the cross-sectional form of a generally U-shaped curve of non constant curvature. The curve is shaped to allow continuous coherent ensonification such that the power in the echo returned from a uniform flat sea floor is substantially constant. This equipment is used for underwater echo sounding and uses hydro acoustic transducers to ensonify the water and receive echoes.

### TECHNICAL FIELD

This invention concerns a sonar antenna. This equipment is used for underwater echo sounding and uses hydro acoustic transducers to ensonify the water and receive echoes.

### BACKGROUND ART

Active sonar antenna systems collect information about the direction of objects or sound sources as well as their range. In order to achieve angular resolution the antenna must have directional properties. A simple antenna comprises a single hydro acoustic transducer which alternates between transmitting and receiving. If the transducer has an acoustic surface that is large compared to the wavelength being transmitted and received, it will possess a directivity of its own. Alternatively a number of individual omnidirectional transducers may be arrayed and operated to obtain the desired directivity.

In general a transducer array will transmit maximum intensity in a principal direction of radiation, and will also transmit side lobes of lesser intensity offset from the principal direction of radiation. The overall pattern is known as the ‘beam pattern’, and the antenna is generally operated using a process called ‘beam forming’ to achieve a desired pattern. Beam forming can be achieved mechanically or electronically.

The transmission pattern can be analysed as the linear combination of spherical wavelets that originate at the locations of the single transducers of the array; they are superimposed following Huygen's principle. The sum of spherical wavelets in front of the antenna forms an interference field. The interference field consists of zones with a higher or lower sound pressure. In the vicinity of the antenna, that is in the near field, the interference pattern changes with respect to angle and range. Far from the antenna, in the far field, spherical waves are formed and the angular distribution of pressure is independent of range. The beam pattern for a receiver is essentially the same as a transmitter.

The transducers may be arrayed in different formations, such as planar, circular, cylindrical or spherical arrays. Alternatively, transducers may be arranged for instance on the hull of a ship.

Multi beam echo sounders, or swath echo sounders, are useful for hydrographic applications. A single planar transducer array may be mounted under the ship, or two planar transducer arrays may be mounted at right angles to each other, one on either side of the ship. These antennas are operated to create fanned beams transverse to the ship. In this arrangement the intensity of the echo falls rapidly with distance, and is compensated by changing the gain of the receiving transducers in a predetermined manner.

### SUMMARY OF THE INVENTION

In a first aspect, the invention is a sonar antenna comprising an axially symmetric acoustic surface having the cross-sectional form of a generally U-shaped curve of non constant curvature; wherein the curve is shaped to allow continuous coherent ensonification such that the power in the echo returned from a uniform flat sea floor is substantially constant.

The curve may be catenary, hyperbolic or parabolic. In particular it may have the form:
y(x)=(cos h(Ax)−1)/A (1)

where x is across, y is vertical and A is constant.

The U-shape cross-section of the acoustic surface may extend unchangingly in the axial direction.

There may be one such acoustic surface for both transmitting and receiving. Optionally, there may be separate such acoustic surfaces for transmission and reception, in which case both will have the same U-shaped cross-section.

A transmitting transducer may be arranged with a single transmitting aperture extending over the entire transmitting surface. Optionally, there may be a plurality of transmitting transducers each having the same U-shaped cross-section and stacked together in the axial direction.

A plurality of receiving transducers may be strung together and arranged along the U-shaped receiving surface. The transducers may be arranged contiguously along the surface or they may be spaced apart along the surface. Not all of the transducers are necessarily employed.

In a second aspect the invention is a vessel equipped with a sonar antenna in accordance with the first aspect, or any embodiments thereof, where the sonar antenna is mounted coaxially along its undersurface.

When mounted below a vessel, usually under the centre of the vessel, the antenna will ensonify water on both sides of the axis of the vessel as well as at a downwardly directed nadir.

The antenna is useful for multi beam echo sounders. It can ensonify a wide swath, provide continuous coherent illumination of the sea floor and enjoy the advantage that it is not necessary to change the gain of the receiving transducers to compensate for the intensity of the echo falling with distance. This opens the possibility of having multiple pings in the water since otherwise each ping would require a different gain versus time curve. Survey speeds can, as a result, be increased depending on the ability to compute the received data.

Also, better range is achieved for given transmitted power since there is more efficient allocation of power. Indicative calculations show power rising from 0 dB at nadir, to 10 dB 70° from nadir.

### BRIEF DESCRIPTION OF THE DRAWINGS

An example of the invention will now be described with reference to the accompanying drawings, in which:

FIG. 1 is a graph of a U-shaped curve;

FIG. 2 is an elevation of a sonar antenna segment;

FIG. 3 is an exploded view of a sonar antenna assembly;

FIG. 4 is a pictorial view of the sonar antenna of FIG. 3 assembled, together with additional parts;

FIG. 5 is a table showing the arrangement of transmitting and receiving transducers in the antenna;

FIG. 6 is a table showing the arrangement of pins in a receiving transducer slot; and

FIG. 7 is a graph showing the transmitted beam shape.

### BEST MODE OF THE INVENTION

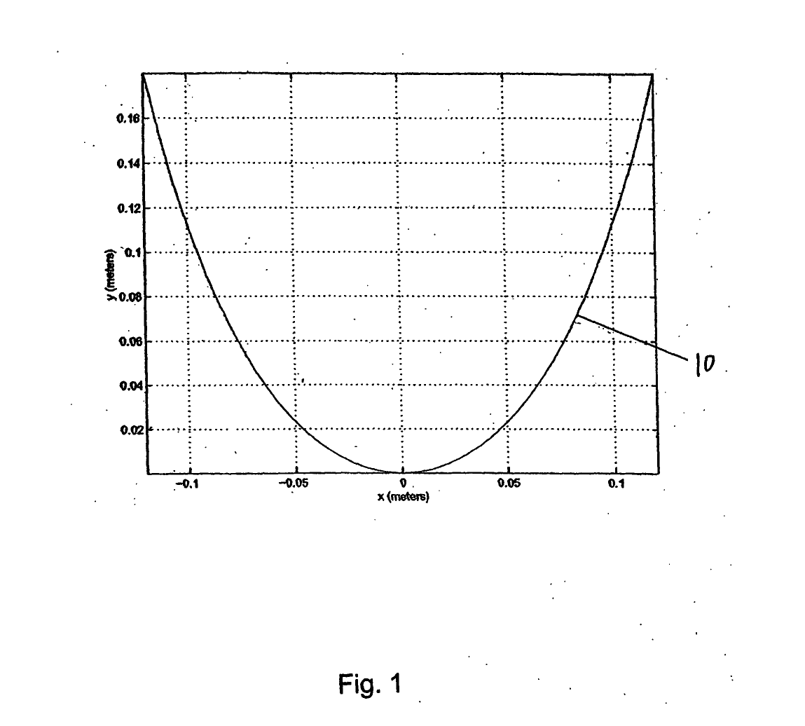

Referring first to FIG. 1, the cross-sectional form of the acoustic surface 10 of a sonar antenna 1 is given as follows:
y(x)=(cos h(Ax)−1)/A (1)

Where x is across-track, andy is vertical.

This equation defines a catenary curve. The constraint which gives A is the slope at which xₘₐₓ is normal to the line joining the array to the edge of the swath. We take the edge of the swath to be at 4× depth, so:

$$\frac{ⅆ y}{ⅆ x} {\vert}_{x = {x}_{max}} = sinh ( A {x}_{max} ) = 4 \qquad ( 2 )$$

yielding A. The arc-length along the curve is given by:
s(x)=sin h(Ax)/A (3)

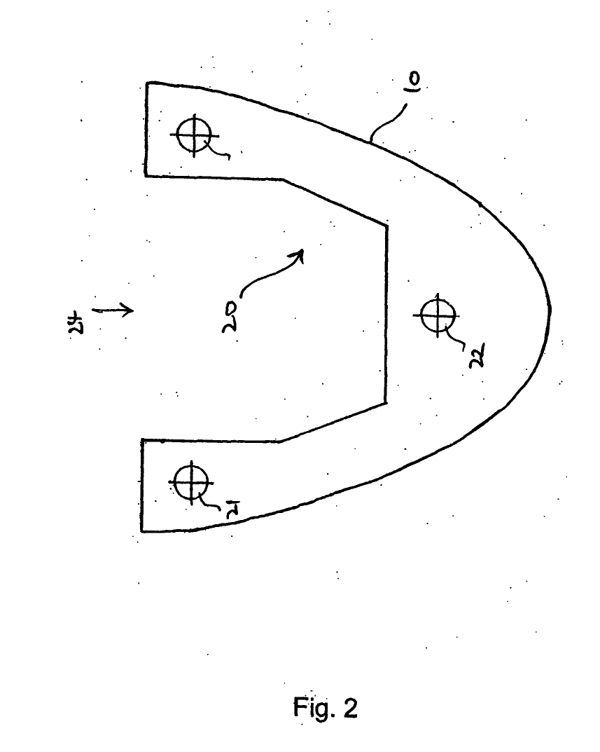

Referring now to FIG. 2 the sonar antenna comprises a series of segments 20 each of which has the cross-sectional form 10. The core of each segment is steel, and the antenna is made from 1-3 composite. Each segment extends in the axial direction and is axially symmetric, so the acoustic surface is in the form of a band extending along the curved surface 10. Three holes 21, 22 and 23 extend through each segment to enable them to be stacked together. A cavity 24 in the interior of the segments house electronics for driving the antenna.

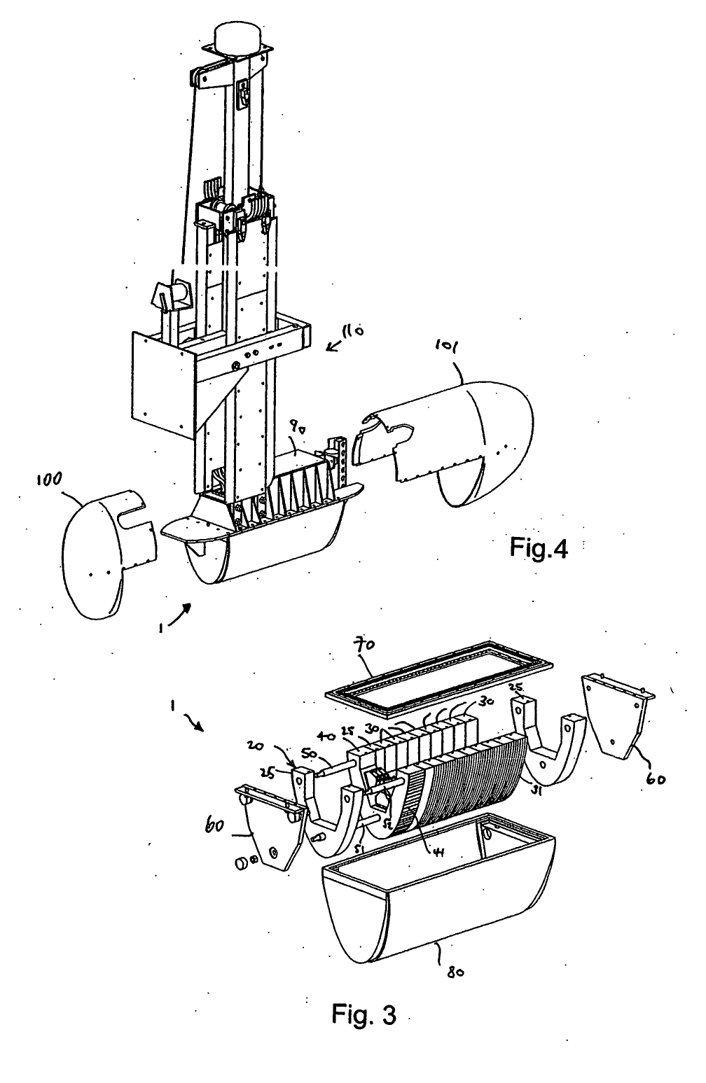

Referring now to FIG. 3 the entire antenna 1 comprises a stack of segments 20. Some are blank 25, but eight of the segments 30 carry transmitting transducer strips, one strip of which is indicated at 31. Each of the transmitting transducers extends along the curved surface 10 from one end to the other. There is a protective skin over the outer (acoustic) surfaces of the transducers.

One of the segments 40 carries a string of receiving transducer slots, one slot of which is indicated at 41. The receiving transducers extend contiguously along the curved surface from one end to the other.

All the segments 25, 30 and 40 are stacked together by mounting them on tie rods 50, 51 and 52 which extend through holes 21, 22 and 23 respectively. End plates 60 are mounted on the ends of the stacks and the whole assembly is secured together with nuts.

Electronics are mounted in the cavity 24 and a top plate 70 is secured to the top. An overmold 80 may be moulded onto the lower surface for protection from the wet environment.

Referring further to FIG. 4, an upper housing 90 is added, and forward and rear farings 100 and 101 provide hydrodynamic performance. A cable riser indicated generally at 110 allows for connection to the rear or underside of a vessel.

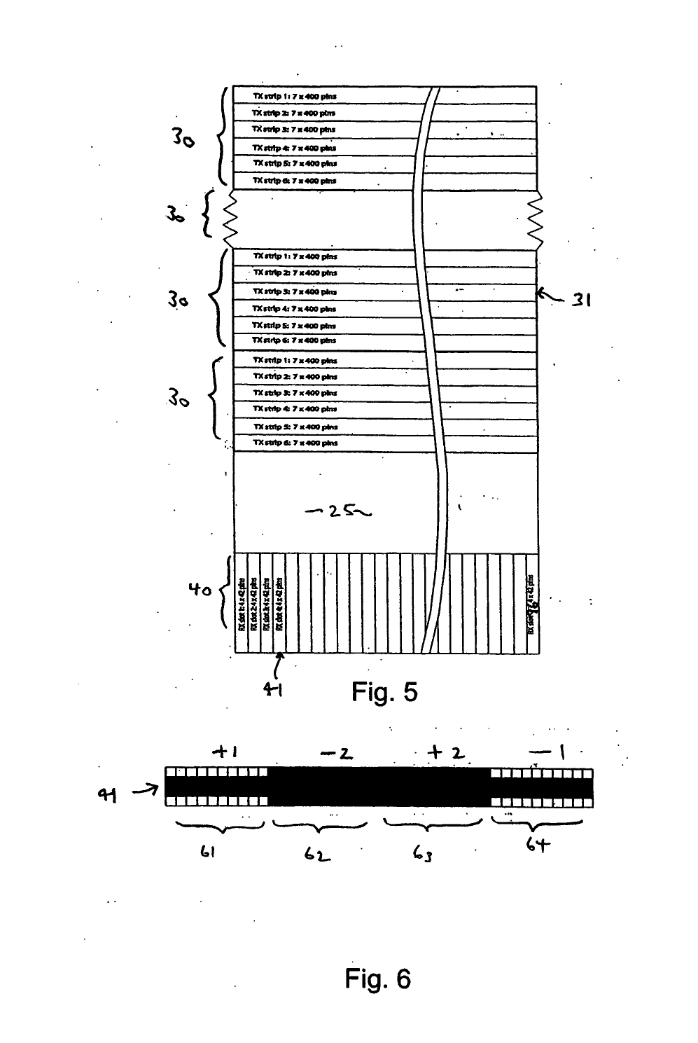

FIG. 5 provides more detail of the arrangement of the transducers. Each transmitter segment 30 carries six strips 31 and each strip carries 3×192 pins. The pin spacing is 3 mm in the horizontal direction and 3 mm vertically. Each strip can be driven independently to shape the transmission beam from each segment. Reducing the strength of the transmission in each end of the strips, say the last 10%, decreases Fresnel diffraction and so reduces ripples in the angular pattern.

The receiver segment 40 comprises ninety-six slots 41. In practice only forty-eight of the receiver slots are used. Each slot can carry 4×42 pins, however as shown in FIG. 6 only 128 pins are positioned in each slot used. The pins are arranged in groups, from the left hand end 61 is an arrangement of 2×10 pins, 62 is 4×42 pins, 63 is 4×42 pins and 64 is 2×10 pins. The forty-eight used slots are selected so that they are not uniformly or regularly spaced since this would damage the angular response of the antenna. The following restraints were placed on the selection: left-right symmetry, a repetition pattern of period twelve and not many large gaps. Otherwise, pattern is as irregular as possible.

The U-shape does not significantly alter in apparent length as the source direction is changed. Furthermore, the gradual trend towards a flatter array section near the array ends gradually increases angular resolution towards the edge of the swath where it is required. As a consequence, the angular resolution of the U-shaped array does not increase or decrease significantly away from nadir, allowing a greater survey swath width.

A diffraction-truncation algorithm is used to generate the complex weights for the receive array. This is not part of the real time processing but numerous tables are prepared in advance and stored for real time use. To produce the tables, each sensor is driven by the exact time series of the transmitted ping. The far field power pattern is a complicated linear function of the complex weights, and the amplitudes and phases of the weights can be solved for the frequency, pulse length, pulse envelope and sensor distribution.

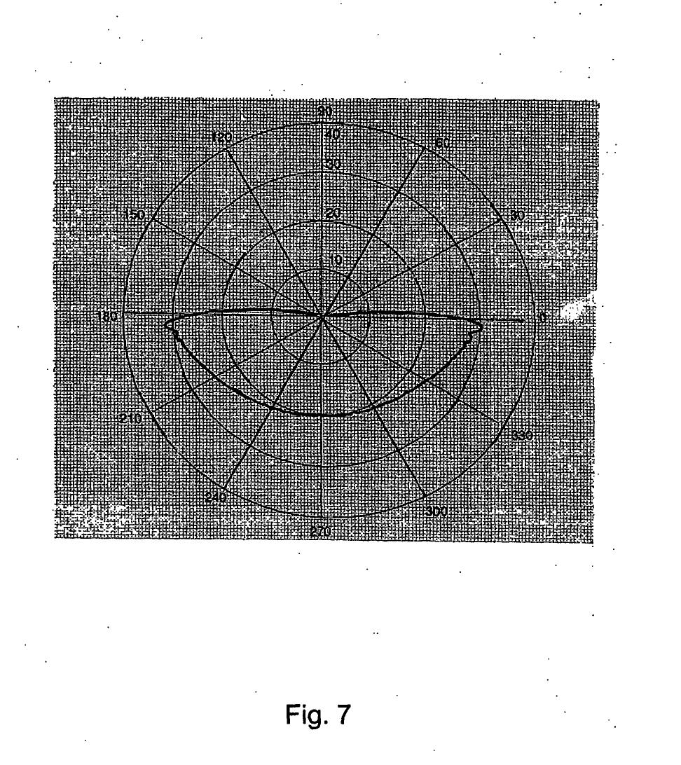

In use the cross-sectional form of the acoustic transmission surfaces allows for a continuous swath of sea floor to be illuminated coherent on either side and under the vessel. The transmission frequency is in the range 100-200 KHz, the width to depth ratio of the swath is 8:1, and the propagation loss range is in the range 60-85 dB. FIG. 7 is a graph of the beam shape, and it can be seen that there is about 12 dB of additional energy to the outer swath, where it is most needed to counter greater absorption and spreading losses.

Of the eight different frequency transmissions made, four are made in the forward direction and four in the rearward direction. As the vessel moves through the water, a coverage map is generated and any gaps can be filled in with the rearward transmission. It is also possible to direct more beams at an object of interest detected by a forward beam. By pointing the beams forward and back it is possible to avoid the problems of receiving a direct reflection when looking vertically down at the sea floor.

Since there is no necessity to change the gain of the receiving transducers to compensate for the intensity of the echo falling with distance. This allows the eight pings to be transmitted before the first is received. Transmission time is jittered so that overlapping pings do not yield ‘railroad tracks’ in the survey data from each transmission's dead time.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A sonar antenna comprising an axially symmetric acoustic surface having the cross-sectional form of a generally U-shaped curve of non constant curvature; wherein the curve is shaped to allow continuous coherent ensonification such that the power in the echo returned from a uniform flat sea floor is substantially constant.

2. A sonar antenna according to claim 1, wherein the curve is catenary, hyperbolic or parabolic.

3. A sonar antenna according to claim 2, wherein the curve has the form:
y(x)=(cos h(Ax)−1)/A
where x is across, y is vertical and A is constant.

4. A sonar antenna according to claim 1, wherein the U-shape cross-section of the acoustic surface extends unchangingly in the axial direction.

5. A sonar antenna according to claim 1, wherein there is one acoustic surface for both transmitting and receiving.

6. A sonar antenna according to claim 1, wherein there are separate acoustic surfaces for transmission and reception, and both have the same U-shaped cross-section.

7. A sonar antenna according to claim 1, wherein a transmitting transducer is arranged with a single transmitting aperture extending over the entire transmitting surface.

8. A sonar antenna according to claim 1, wherein, there are a plurality of transmitting transducers each having the same U-shaped cross-section and stacked together in the axial direction.

9. A sonar antenna according to claim 1, wherein a plurality of receiving transducers are strung together and arranged along the U-shaped receiving surface.

10. A sonar antenna according claim 9, where the transducers are arranged contiguously along the surface.

11. A sonar antenna according claim 9, where the transducers are arranged spaced apart along the surface.

12. A sonar antenna according claim 9, wherein not all the transducers are employed.

13. A vessel equipped with a sonar antenna according to claim 1, where the sonar antenna is mounted coaxially along its undersurface.
